(19) United States
(12) Patent Application Publication
(10) Pub. No.: US 2020/0305383 A1
(43) Pub. Date: Oct. 1, 2020

(54) AUTOMATIC CAT LITTER BOX CLEANSING STRUCTURE

(71) Applicant: MoDoDo Co. Ltd, Taipei City (TW)

(72) Inventor: CHIA-HO HUANG, Taipei City (TW)

(21) Appl. No.: 16/370,710

(22) Filed: Mar. 29, 2019

(51) Int. Cl. A01K 1/01

(52) U.S. Cl. CPC A01K 1/011; A01K 1/0132

(57) ABSTRACT

An automatic cat litter box cleansing structure includes a base on where the cat litter box is disposed; a horizontal movement module movably disposed on the base and transversely moving along the area in which the cat litter box is disposed; a vertical movement module movably disposed on the horizontal movement module and longitudinally move with respect to the horizontal movement module. With the control module controlling the horizontal movement module and the vertical movement module to move, the shoveling member automatically shovels the cat feces away from the cat litter box, achieving an automatic cleansing function.

### BACKGROUND OF THE INVENTION

### 1. Field of the Invention

The present invention relates to cat litter box cleansing devices, and more particularly, to an automatic cat litter box cleansing structure.

### 2. Description of the Related Art

For any houses having a pet cat, a cat litter box is usually a must. With cat litters placed in the cat litter box, the cat gets used to excrete feces on the cat litters, so as to facilitate the subsequent cleansing task. When cleansing the cat litter box, the user often has to manually cleanse the litter, including cleaning away the feces on the used cat litters and replenishing new cat litters. However, the manually cleansing process is troublesome for the user. Also, when the user forgets to cleanse the cat litter box, an environmental odor will be produced.

Referring to TWM430838, a manual reversing device for cleansing cat litter is disclosed. With a holder as a pivot, the main body rotates by 90 degrees for gathering the cat feces to the filtering device, and rotates by 180 degrees for discharging the feces out of the main body; also, dust of the cat litters in the cat litter will fall onto the movable plate of the holder, thus achieving a semi-automatic cat litter cleansing function. However, a manual rotation of the main body is still needed, failing to meet a comprehensive convenience of usage. Also, the user may still forget to carry out the cleansing job.

Therefore, it is desirable to resolve the aforementioned issues occurring when cleansing a conventional cat litter box.

### SUMMARY OF THE INVENTION

For improving the issues above, an automatic cat litter box cleansing structure is disclosed. With a control module controlling the movements of a horizontal movement module and a vertical movement module, the shoveling member shovels the used cat litter in the cat litter box, so as to cleanse the cat feces out of the cat litter box.

An automatic cat litter box cleansing structure in accordance with an embodiment of the present invention comprises:

a base on which a cat litter box is disposed;

a horizontal movement module movably disposed on the base, so as to transversely move in a region in which the cat litter box is disposed;

a vertical movement module movably disposed on the horizontal movement module, so as to longitudinally move with respect to the horizontal movement module, the vertical movement module having a shoveling member; and

a control module applied for controlling the horizontal movement module and the vertical movement module to drive the shoveling member for shoveling an used cat litter in the cat litter box, thereby cleansing the used cat litter away from the cat litter box.

By use of the controlling module, the horizontal movement module is controlled to transversely move along the area of the cat litter box, and the vertical movement module is controlled to longitudinally move with respect to the horizontal movement module, such that the shoveling member is driven by the horizontal movement module to shovel the used cat litter away from the cat litter box, achieving an automatically cleansing effect and preventing environmental odor occurring from the used cat litter.

Preferably, a storage room is disposed beside the cat litter box for storing new cat litter for replenishment. Also, the storage room has a cat litter supplying module electrically connected to the control module for replenishing new cat litter stored in the storage room into the cat litter box.

Therefore, cat feces combined with the used cat litter are shoveled out of the cat litter box, and new cat litter is supplied into the cat litter box via the cat litter supplying module for maintaining a sufficient cat litter in the cat litter box.

### BRIEF DESCRIPTION OF THE DRAWINGS

FIG. 1 is a perspective view of the automatic cat litter box cleansing structure in accordance with an embodiment of the present invention.

FIG. 2 is an exploded view of the automatic cat litter box cleansing structure in accordance with an embodiment of the present invention.

FIG. 3 is a schematic perspective view illustrating the installation of the horizontal movement module and the vertical movement module.

FIG. 4 is an exploded view of the horizontal movement module and the vertical movement module.

FIG. 5 is a schematic side view illustrating the installation of the horizontal movement module and the vertical movement module.

FIG. 6 is a schematic view illustrating the shoveling member having the slide block in alignment with the control member and moving upward along with the vertical movement module.

FIG. 7 is a schematic view illustrating the slide block in FIG. 6 being pushed to the lower position by the control member.

FIG. 8 is a schematic view illustrating the block member in alignment with the control member and vertically moving upward along with the vertical movement module, so as to leave the slide block.

FIG. 9 is a structural block view of the circuit of the control module of the present invention.

FIG. 10 is a schematic view illustrating the cat litter supplying module replenishing the cat litter into the cat litter box.

FIG. 11 is a schematic view illustrating the block door being pushed to open by the transverse movement of the horizontal movement module, and the feces container being taken out from the base.

FIG. 12 is a schematic view illustrating the shoveling member shoveling the cat litter in the cat litter box.

FIG. 13 is a schematic view illustrating the shoveling member having the first shovel carrying out the shoveling motion at a shallow position.

FIG. 14 is a schematic view illustrating the shoveling member having the second shovel carrying out the shoveling motion at a deep position.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

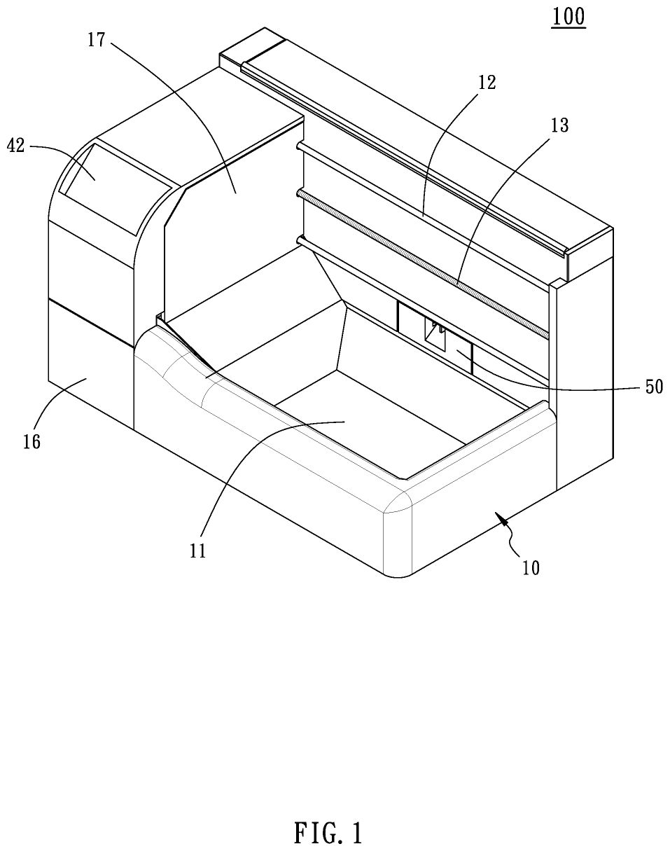

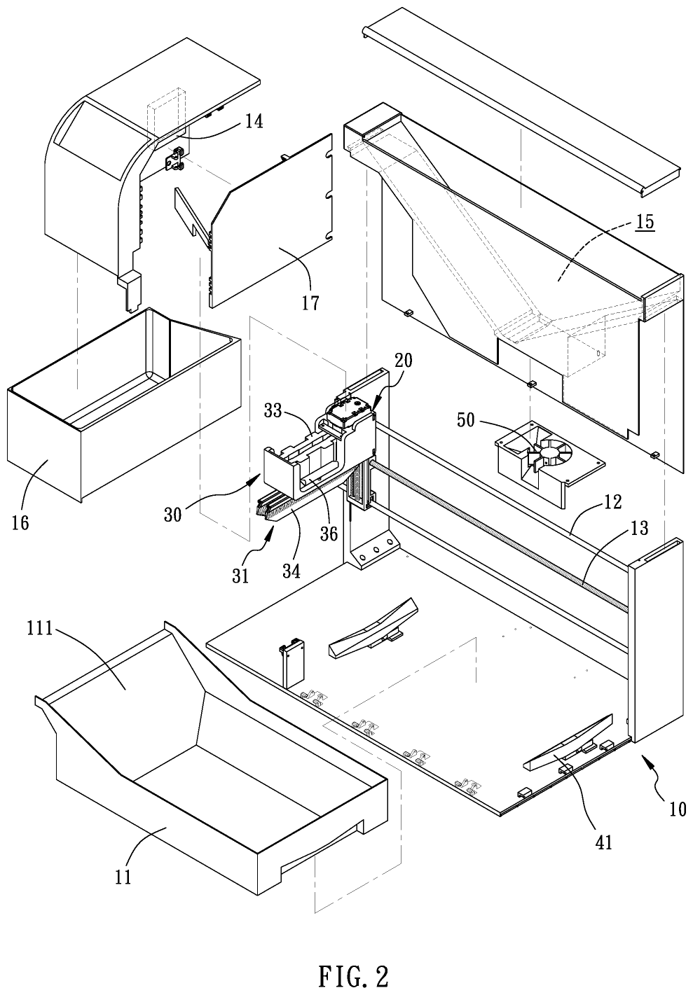

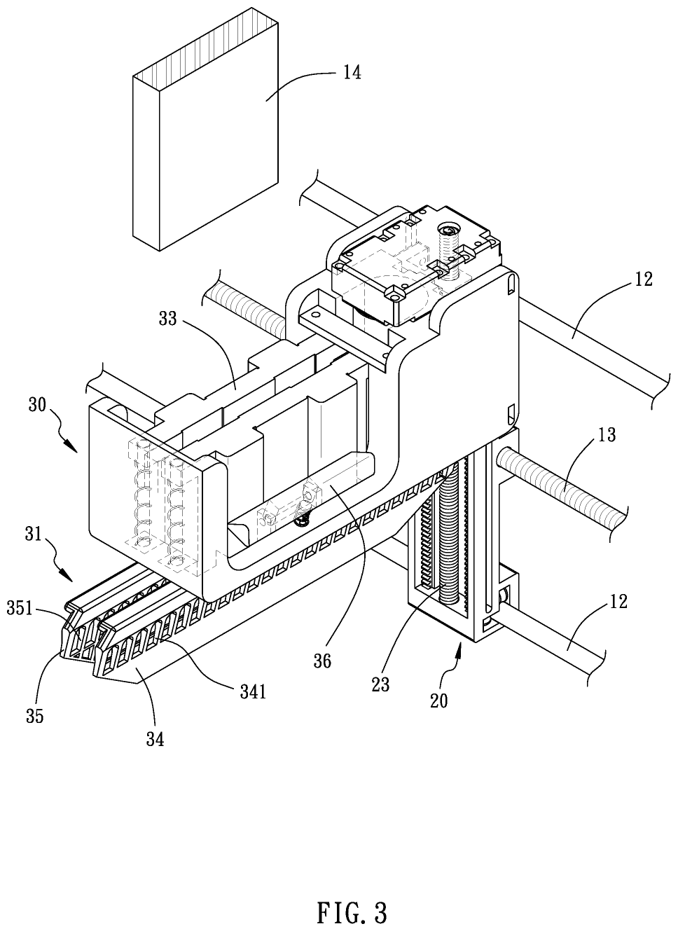

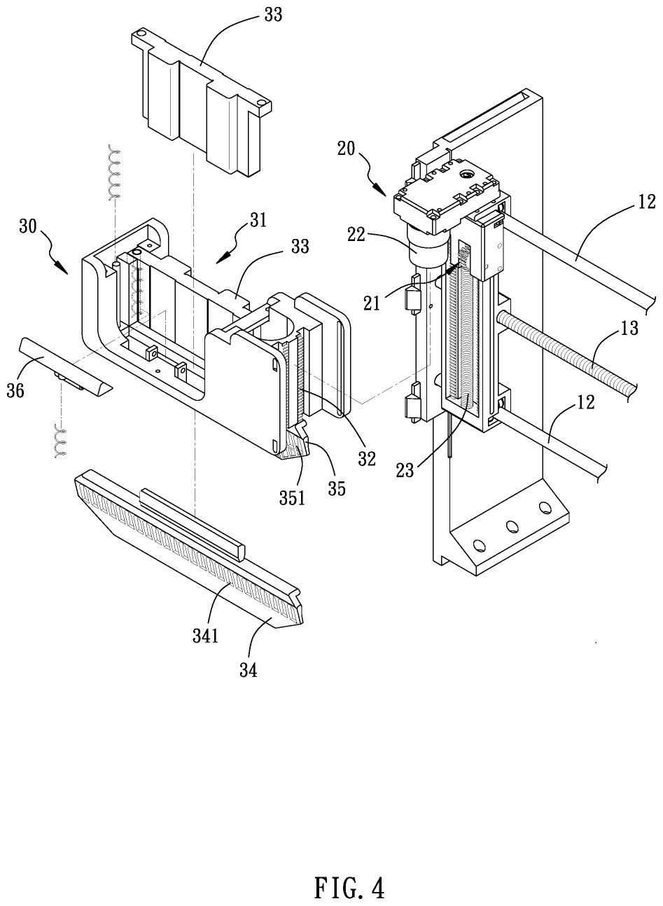

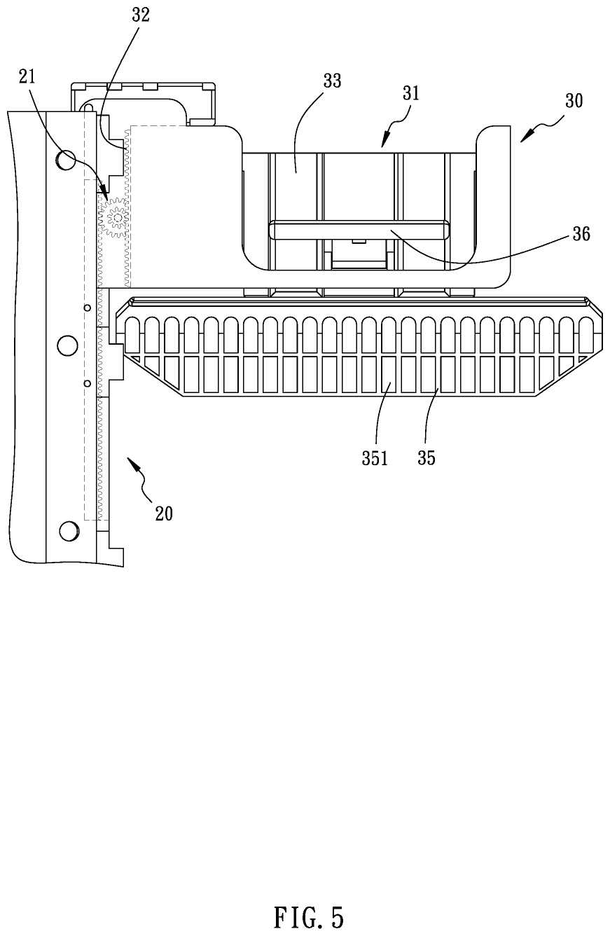

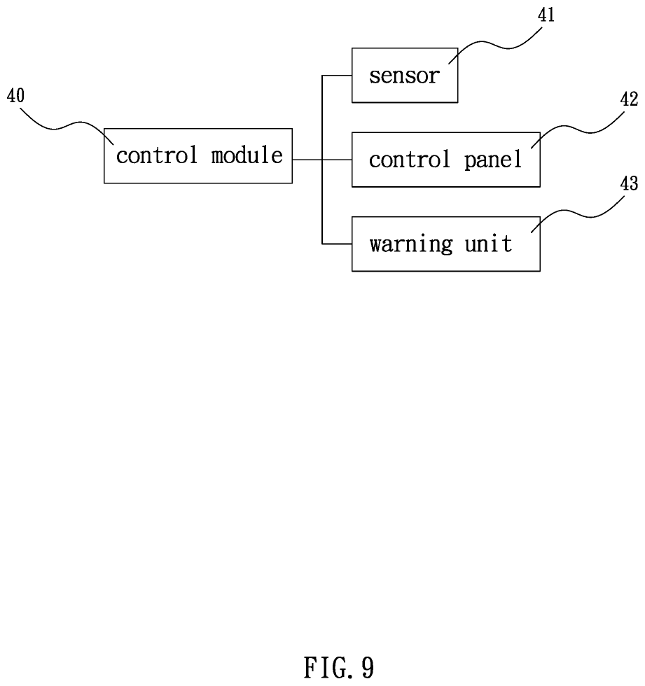

Referring to FIG. 1 to FIG. 14, an automatic cat litter box cleansing structure 100 comprises a base 10, a horizontal movement module 20, a vertical movement module 30, and a control module 40.

The base 10 is applied for holding a cat litter box 11 in which the cat litter is disposed, such that a cat is allowed to excrete feces in the cat litter box 11. The horizontal movement module 20 is movably disposed on the base 10, and the vertical movement module 30 is movably disposed on the horizontal movement module 20. The horizontal movement module 20 is allowed to transversely move along an area in where the cat litter box 11 is disposed. The vertical movement module 30 is allowed to longitudinally move with respect to the horizontal movement module 20. In an embodiment of the present invention, the vertical movement module 30 has two shoveling members 31. Therefore, the two shoveling members 31 is able to longitudinally move along with the vertical movement module 30 and transversely move along with the horizontal movement module 20. In other words, the two shoveling members 31 are allowed to be biaxially move in the base 10. The control module 40 is applied for controlling the transverse movement of the horizontal movement module 20 and the longitudinal movement of the vertical movement module 30. Under the control of the control module 40, the shoveling members 31 are driven to shovel the used cat litter out, so as to cleanse the cat feces from the cat litter box 11.

In an embodiment of the present invention, the base 10 has two transversely oriented guidance rods 12 on wherein the horizontal movement module 20 is disposed. Also, the horizontal movement module 20 is driven by a transverse thread rod 13, such that the horizontal movement module 20 is allowed to transversely move on the two guidance rods 12. Preferably, the horizontal movement module 20 is driven to rotate clockwise or counterclockwise by the transverse thread rod 13 which is motivated by a motor 231 (not shown).

In an embodiment of the present invention, the horizontal movement module 20 has a gear set 21, and the vertical movement module 30 has a teeth row 32, such that the teeth row 32 is geared by the gear set 21, whereby the gear set 21 motivates the teeth row 32 for driving the vertical movement module 30 to longitudinally move. Preferably, the gear set 21 is driven to rotate clockwise or counterclockwise by a longitudinal thread rod 23 motivated by the motor 22.

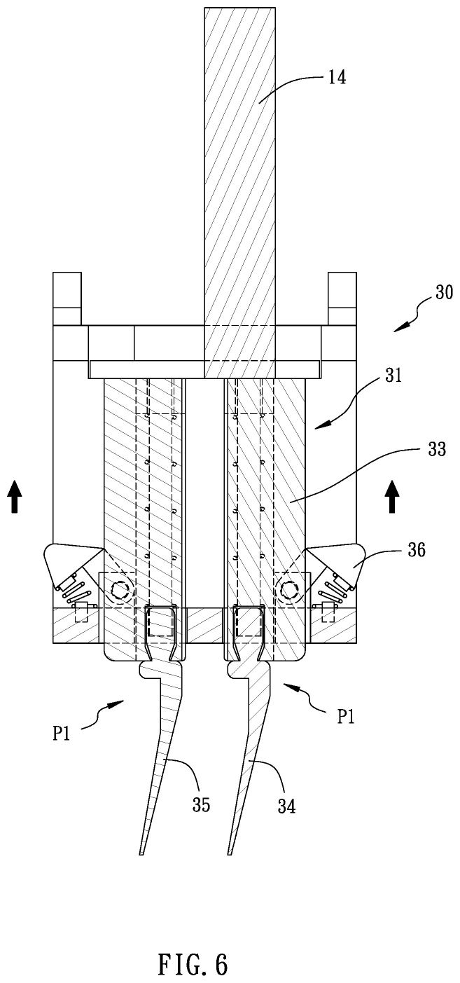

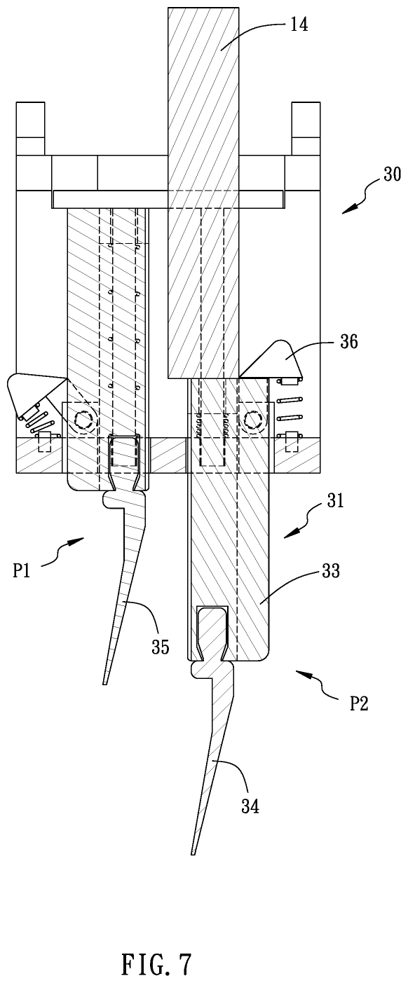

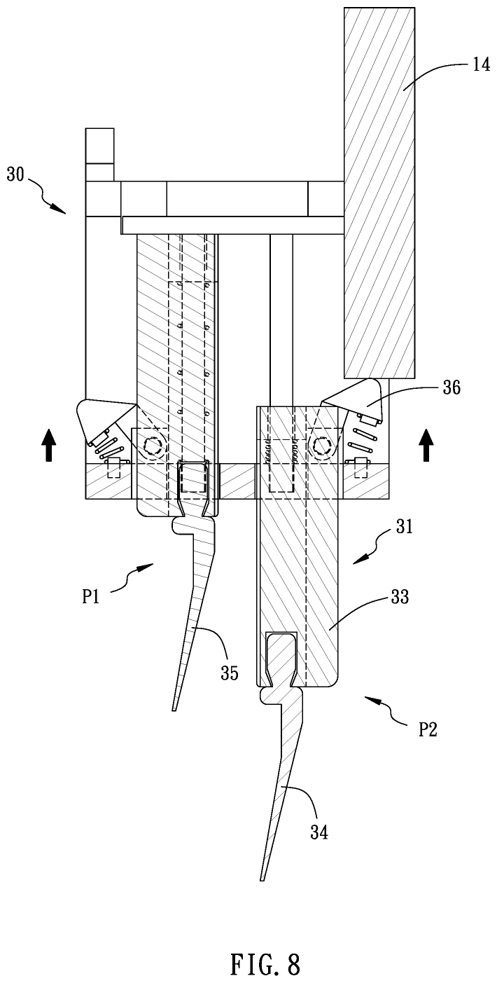

In an embodiment of the present invention, each of the two shoveling members 31 has a slide block 33, wherein one of the shoveling members 31 has a first shovel 34, and the other shoveling member 31 has a second shovel 35. Each slide block 33 is allowed to vertically move on the vertical movement module 30 between an upper position P1 and a lower position P2 (as shown by FIG. 6 to FIG. 8). The first shovel 34 and the second shovel 35 are disposed on the bottom of the two slide blocks 33, respectively. The vertical movement module 30 has two block members 36 corresponding to the two slide blocks 33, respectively. Therefore, when each slide block 33 is at the lower position P2 (as shown by FIG. 7), the slide block 33 is blocked by the corresponding block member 36 to be positioned. When the block member 36 is separated from the slide block 33 (as shown by FIG. 8), the slide block 33 is resiliently restored back to the upper position P1. In an embodiment of the present invention, the first shovel 34 has a row of screen bores 341 disposed on the upper portion of the first shovel 34, and the second shovel 35 has two rows of screen bores 351 disposed on both the upper and lower portions of the second shovel 35. The first shovel 34 and the second shovel 35 are applied for shoveling the cat litter in the cat litter box 11, and the screen bores 341, 351 are applied for screening out the unused cat litter during shoveling the cat litter. However, forms of the screen bores 341, 351 in the embodiment are only for illustration of the technical features and by no means limiting the embodiment scope of the present invention.

In an embodiment, the base 10 is provided with a control member 14 corresponding to the vertical movement module 30. During the vertically upward movement of the vertical movement module 30 with respect to the corresponding slide block 33, the slide block 33 is pushed to the lower position P2 by the control member 14 (as shown by FIG. 7). Similarly, during the vertically upward movement of the vertical movement module 30 with respect to the block member 36, the block member 36 is pushed by the control member 14 to be separated from the slide block 33 (as shown by FIG. 8), such that the slide block 33 is resiliently restored back to the upper position P1. With the pushing motion of the control member 14, the two shoveling member 31 are able to be alternately applied for shoveling the cat litter.

In an embodiment of the present invention, the base 10 has a sensor 41 electrically connected with the control module 40 for sensing if the cat is in the cat litter box 11. Preferably, the sensor 41 is a weight sensor for sensing the weight of the cat litter box 11. When the cat enters the cat litter box 11 to excrete feces, the sensor 41 senses that the weight of the cat litter box 11 becomes heavier; when the cat finishes the excretion and leaves the cat litter box 11, the sensor 41 senses that the weight of the cat litter box 11 becomes lighter. Then, via the control of the controlling module 40, the shoveling member 31 is driven to shovel the cat litter in the cat litter box 11, whereby the feces are shoveled out from the cat litter box 11. The sensor 41 is not limited to a weight sensor; in other embodiments, the sensor 41 is also allowed to be an infrared sensor (not shown), so as to identify the cat by the body temperature of the cat when the cat enters or leave the cat litter box 11.

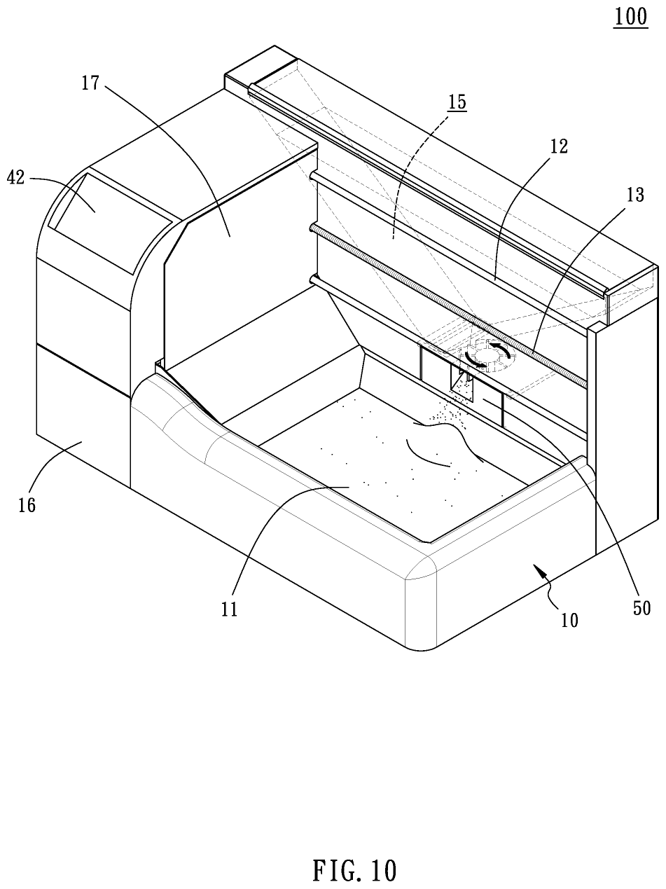

In an embodiment of the present invention, the base 10 has a storage room 15 disposed besides the cat litter box 11 for storing new cat litter. Also, the storage room 15 has a cat litter supplying module 50 electrically connected with the control module 40 for replenishing the new cat litter into the cat litter box 11 (as shown by FIG. 10). In the embodiment, the control module 40 is disposed on the base 10 and has a control panel 42, such that, through the operation on the control panel 42, the cat litter supplying module 50 is driven to supply the new cat litter into the cat litter box 11. Also, in the embodiment, the control module 40 has a warning unit 43. When the cat litter stored in the storage room 15 is less than a predetermined amount (such as 1 kilo), the warning unit 43 sends out a warning for reminding the user to add new cat litter into the storage room 15, so as to prevent the insufficiency of the cat litter storage.

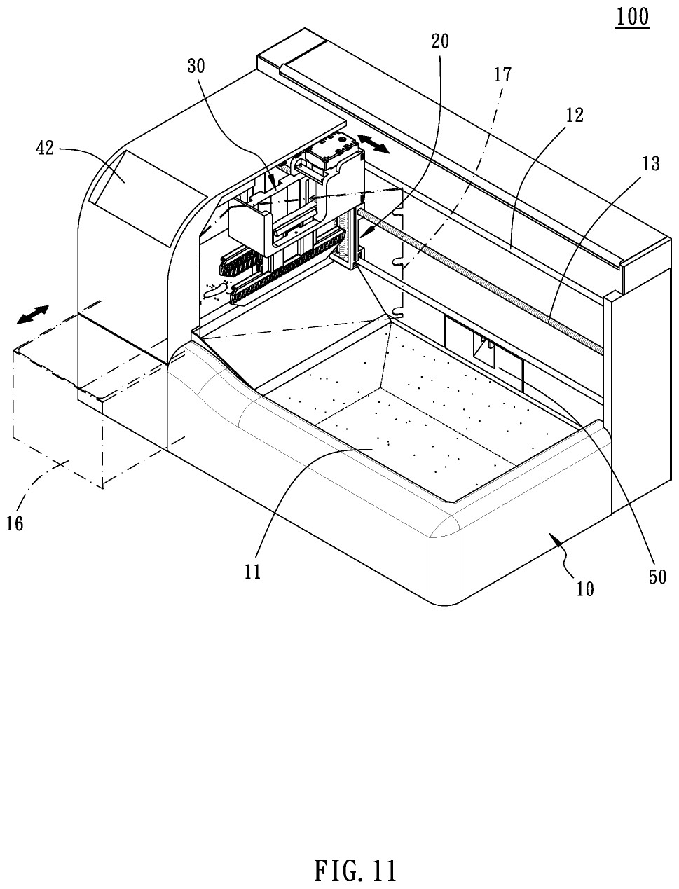

In an embodiment, the base 10 has a feces container 16 disposed on one side away from the cat litter box 11 for housing the shoveled cat feces. Also, the feces container 16 is able to be taken out from the base 10 (as shown by FIG. 11) for cleansing the cat feces therein. In addition, the cat litter box 11 has a bevel 111 disposed on one side of the feces container 16. When the shoveling member 31 shovels the cat feces into the feces container 16, the shoveling member 31 is controlled to shake on the bevel 111, such that the unused cat litter shoveled up by the shoveling member 31 fall back to the cat litter box 11 via the bevel 111, thus preventing a waste of the cat litter. When the cat feces housed in the feces container 16 has to be cleansed (such as the amount thereof is more than 10 kilos), the warning is also able to be sent by the warning unit 43 for reminding the user to cleanse the cat feces.

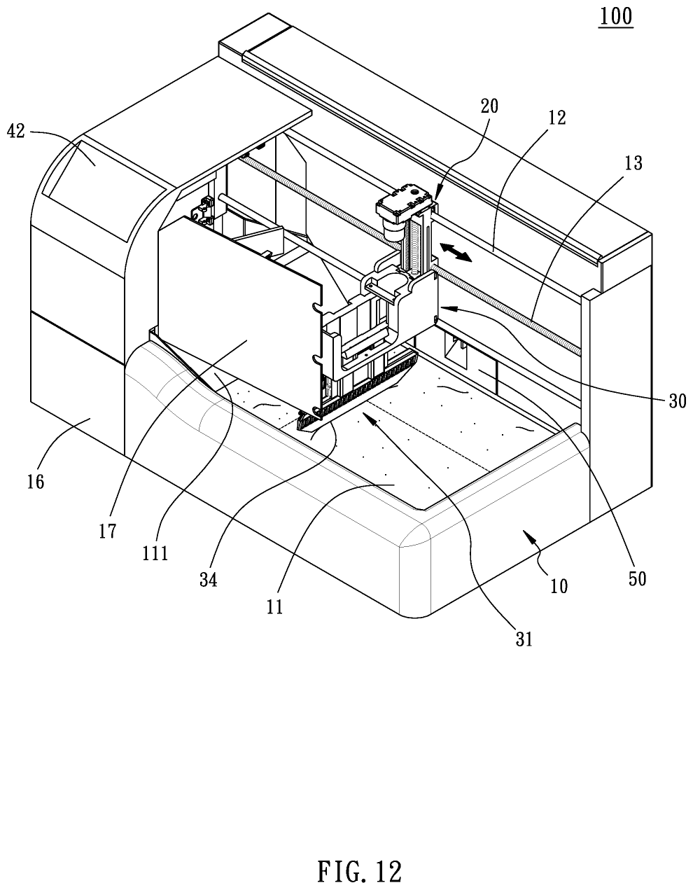

In an embodiment of the present invention, the base 10 has a block door 17 on one side thereof adjacent to the cat litter box 11 for blocking the horizontal movement module 20 and the vertical movement module 30. When the horizontal movement module 20 transversely move toward the cat litter box 11, the block door 17 is pushed by the horizontal movement module 20 to open (as shown by FIG. 11 to FIG. 12). When the horizontal movement module 20 transversely move back toward the feces container 16, the block door 17 is pushed by the horizontal movement module 20 to close.

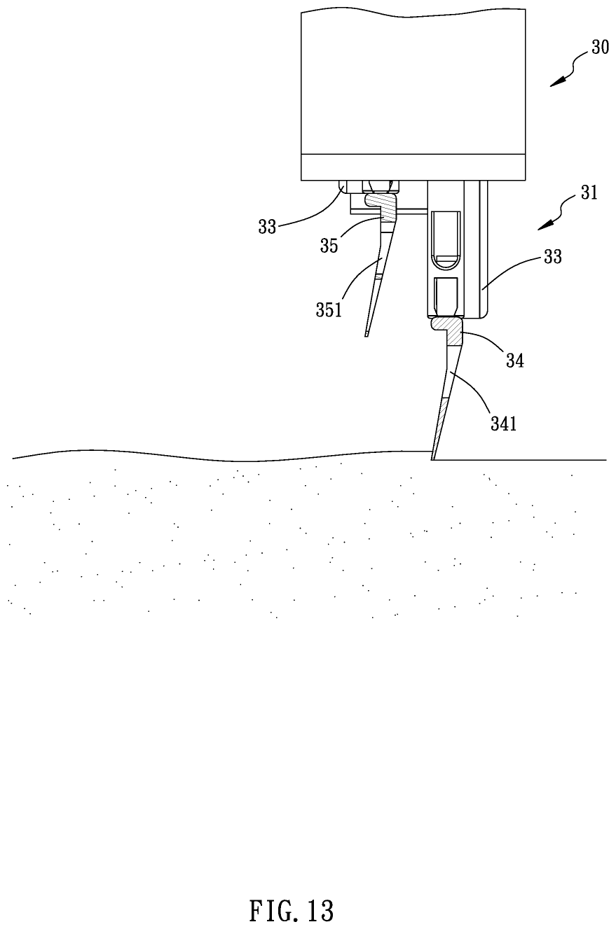

During the operation of the automatic cat litter box cleansing structure 100, when the first shovel 34 is first applied for cleansing the cat litter in the cat litter box 11, following steps are carried out: the control member 14 pushing the slide block 33 and the first shovel 34 to the lower position P2 via the transverse movement of the horizontal movement module 20 and the longitudinal movement of the vertical movement module 30; the vertical movement module 30 longitudinally moving upward with respect to the horizontal movement module 20; the horizontal movement module 20 transversely moving to above the cat litter box 11 for open the block door 17 (ah shown by FIG. 11 to FIG. 12); the vertical movement module 30 longitudinally moving lower with respect to the horizontal movement module 20 for placing the first shovel 34 to a shallow position (as shown by FIG. 13); the horizontal movement module 20 transversely moving to carry the cat feces toward the feces container 16 and shaking on the bevel 111, whereby the unused cat litter falls back to the cat litter box 11; and the first shovel 34 carrying the cat feces to the feces container 16 in which the cat feces are housed. Therefore, the first shovel 34 finishes the cat litter cleansing operation in the cat litter box 11.

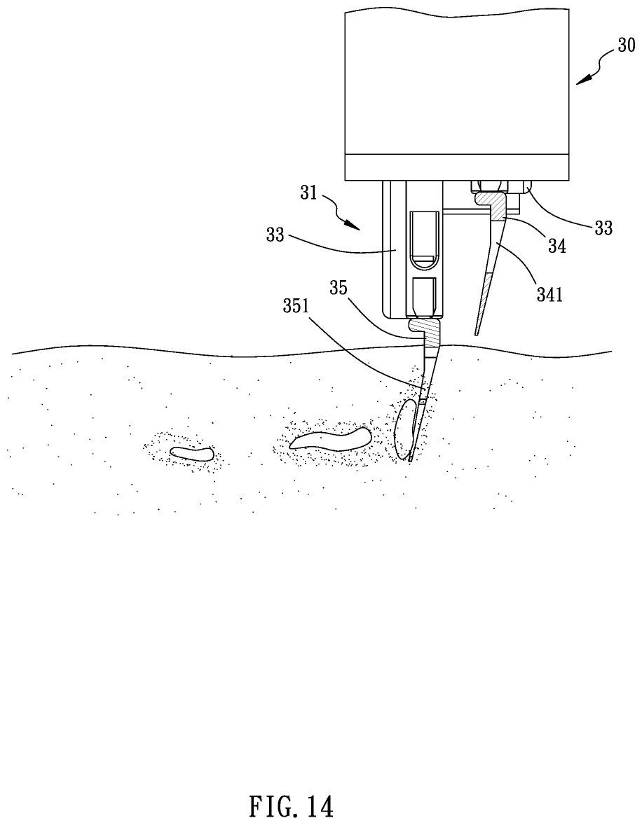

After the completion of the cat litter cleansing operation of the first shovel 34, the horizontal movement module 20 again moves to the control member 14 and longitudinally move upward with the vertical movement module 30 with respect to the block member 36. The block member 36 is pushed by the control member 14 to be separated from the slide block 33, such that the first shovel 34 is restored to the upper position P1. The second shovel 35 moves between the lower position P2 and the upper position P1. Similarly, the second shovel 35 moves via the transverse movement of the horizontal movement module 20 and the longitudinal movement of the vertical movement module 30, and the control member 14 then pushes the slide block 33 and the second shovel 35 together, such that the second shovel 35 is allowed to shovel the cat litter at a deeper position (as shown by FIG. 14) for carrying out the cat litter cleansing operation in the cat litter box 11. Also, the block member 36 is pushed by the control member 14 to be separated from the slide block 33, whereby the second shovel 35 is restored back to the upper position P1.

With the foregoing configuration, the present invention achieves following advantageous function. The horizontal movement module 20 is controlled by the control module 40, so as to transversely move along the area in which cat litter box 11 is disposed, and the vertical movement module 30 longitudinally move with respect to the horizontal movement module 20. Therefore, when a cat finishes feces excretion in the cat litter box 11, the shoveling member 31 is driven by the horizontal movement module 20 to shovel the cat litter in the cat litter box 11, so as to automatically cleanse the cat feces away from the cat litter box 11. Compared with the conventional cleansing method which manually cleanses or applies a semi-automatic cat litter box to cleanse cat feces, the present invention achieves a greater convenience of automatic cleansing the cat litter box 11. Also, the user of the present invention is prevented from forgetting to cleanse the cat feces, and further prevents environmental odor from occurring thereby.

In addition, when a cat excretes feces in the cat litter box 11, the cat feces will be combined with the cat litter to form larger bulks, which are then shoveled away from the cat litter box 11 by the shoveling member 31. As a result, the cat litter in the cat litter box 11 is shoveled away, causing a consumption of the cat litter reserve in the cat litter box 11. With the storage room 15 housing a certain amount of new cat litter, upon the weight of cat litter in the cat litter box 11 decreasing to a certain level, the cat litter supplying module 50 will replenish the new litter into the cat litter box 11, thereby maintaining a sufficient amount of cat litter in the cat litter box 11 and continuously facilitating the cat feces cleansing function.

Although particular embodiments of the invention have been described in detail for purposes of illustration, various modifications and enhancements may be made without departing from the scope of the invention. Accordingly, the invention is not to be limited except as by the appended claims.

What is claimed is:

1. An automatic cat litter box cleansing structure, comprising:
a base on where a cat litter box is disposed;
a horizontal movement module movably disposed on the base and transversely moving along an area in which the cat litter box is disposed;
a vertical movement module movable disposed on the horizontal movement module and longitudinally moving with respect to the horizontal movement module, the vertical movement module further having a shoveling member; and
a control module applied for controlling the horizontal movement module and the vertical movement module to drive the shoveling member to shovel a cat litter in the cat litter box, such that the cat litter is shoveled away from the cat litter box.

2. The automatic cat litter box cleansing structure of claim 1, wherein the base has a plurality of transverse guidance rods; the horizontal movement module is disposed on the transverse guidance rods and driven by a transverse thread rod to transversely move on the transverse guidance rods.

3. The automatic cat litter box cleansing structure of claim 2, wherein the horizontal movement module has a gear set, and the vertical movement module has a teeth row engaged with the gear set; the gear set is driven to rotate clockwise or counterclockwise by a longitudinal thread rod which is motivated by a motor, such that the gear set motivates the teeth row for driving the vertical movement module to longitudinally move.

4. The automatic cat litter box cleansing structure of claim 3, wherein the shoveling member comprises a slide block and a shovel member; the slide block longitudinally move on the vertical movement module between an upper position and a lower position; the shovel member is disposed on a bottom portion of the slide block and has a screen bore; the vertical movement module has a block member corresponding to the slide block, such that when the slide block is at the lower position, the slide block is blocked by the block member to be positioned, and when the block member is separated from the slide block, the slide block is resiliently restored to the upper position.

5. The automatic cat litter box cleansing structure of claim 4, wherein the base has a control member corresponding to the vertical movement module; when the vertical movement module longitudinally move upward with respect to the slide block, the slide block is pushed by the control member to the lower position; when the vertical movement module longitudinally move upward with respect to the block member, the block member is pushed by the control member to be separated from the slide block.

6. The automatic cat litter box cleansing structure of claim 5, wherein a plurality of the shoveling members are included, such that the shoveling members are alternately pushed by the control member to operate.

7. The automatic cat litter box cleansing structure of claim 1, wherein the base has a sensor which is electrically connected with the control module for sensing if a cat is in the cat litter box.

8. The automatic cat litter box cleansing structure of claim 7, wherein the sensor is selected from a group consisting of infrared sensor and weight sensor.

9. The automatic cat litter box cleansing structure of claim 1, wherein the base has a storage room disposed besides the cat litter box for housing new cat litters, and the storage room has a cat litter supplying module which is electrically connected with the control module for replenishing the new cat litter from the storage room into the cat litter box.

10. The automatic cat litter box cleansing structure of claim 9, wherein the control module has a warning unit which sends out a warning when a weight of the new litter in the storage room is lower than a predetermined weight for indicating that the new cat litter in the storage room needs to be replenished.

11. The automatic cat litter box cleansing structure of claim 1, wherein the base has a feces container disposed on one side of the base away from the cat litter box for housing cat feces that are shoveled from the cat litter box, and the feces container is able to be taken out from the base for cleansing the cat feces.

12. The automatic cat litter box cleansing structure of claim 11, wherein the cat litter box has a bevel on one side adjacent to the feces container, such that when the cat feces are shoveled by the shoveling member to the feces container, the shoveling member is controlled to shake on the bevel, whereby the cat litters fall back to the cat litter box via the bevel.

13. The automatic cat litter box cleansing structure of claim 1, wherein the control module has a control panel disposed on the base.

14. The automatic cat litter box cleansing structure of claim 1, wherein the base has a block door on one side adjacent to the cat litter box for blocking the horizontal movement module and the vertical movement module; when the horizontal movement module transversely move toward the cat litter box, the block door is pushed to open.
